(19) United States
(12) Patent Application Publication
(10) Pub. No.: US 2025/0209901 A1
(43) Pub. Date: Jun. 26, 2025

(54) INTELLIGENT TRACKING SYSTEM AND METHOD

(71) Applicant: Everywhere Communications, Annapolis, MD (US)

(72) Inventors: Brian Stam, Yarmouth, ME (US); Derek Fischer, Washington, DC (US)

(21) Appl. No.: 18/989,367

(22) Filed: Dec. 20, 2024

Related U.S. Application Data
(60) Provisional application No. 63/612,651, filed on Dec. 20, 2023.

(51) Int. Cl. G08B 21/04

(52) U.S. Cl. CPC G08B 21/04; G08B 21/0453

(57) ABSTRACT

Methods and systems for intelligent tracking include receiving a protected start time and a protected end time for a task assigned to a first user from a monitoring system. The first user is associated with at least one tracking device. The method also includes determining a protected time based on the protected start time and the protected end time. The method includes determining a protected area associated with the task. The method further includes receiving a current location of the first user and receiving movement information about the first user from the tracking device. Upon determining the protected time has expired, the current location of the first user is within the protected area, the method includes transmitting an alert to one or more devices based on the movement information.

### CROSS REFERENCES TO RELATED APPLICATIONS

The following application claims priority under 35 U.S.C. § 119 (e) to U.S. Provisional Patent Application Ser. No. 63/612,651 filed Dec. 20, 2023, entitled INTELLIGENT TRACKING SYSTEM AND METHOD. Priority is claimed for all the above-identified applications and publication, all of which are expressly incorporated herein by reference in their entireties for all purposes.

### TECHNICAL FIELD

The present disclosure generally relates to an intelligent tracking system and method of use, and specifically to an intelligent tracking system that reduces false alarms by implementing user specific criteria.

### BACKGROUND

In many localities, employers have an obligation to provide safety and security tools to meet their duty of care to persons (e.g., employees) who are alone (lone persons) or persons (e.g., employees) in high-risk situations (endangered persons). This obligation often involves a check-in feature, wherein the lone or endangered person confirms that the said person has not become incapacitated. A common and costly problem with current check-in systems are that alerts are often falsely or incorrectly generated for persons who are not at risk, solely because a check in time was missed or ignored. This generates false-positive alerts, which can lead to alarm fatigue and alerts being ignored.

### SUMMARY

According to one aspect, the method includes receiving a protected start time and a protected end time for a task assigned to a first user from a monitoring system, where the first user is associated with at least one tracking device. The method also includes determining a protected time based on the protected start time and the protected end time. The method furthermore includes determining a protected area associated with the task, the protected time and the first user, based on geospatial data. The method includes receiving a current location of the first user from the tracking device and receiving movement information about the first user from the tracking device. The method also includes upon determining the protected time has expired, the current location of the first user is within the protected area, transmitting an alert to one or more devices based on the movement information.

According to another aspect, a computing system includes a monitoring system, a tracking device associated with a first user, where the tracking device has a position determination device. The system includes one or more processors operatively connected for computer communication to the monitoring system and the tracking device, and one or more memories storing instructions that when executed by the one or more processors, cause the computing system to perform an intelligent tracking process, including: determining a protected time based on a protected start time and a protected end time received from the monitoring system, where the protected time is associated with a task assigned to the first user; determining a protected area based on geospatial data from the monitoring system and the tracking device, where the protected area is associated with the task, the protected time and the first user; receiving a current location of the first user from the position determination device of the tracking device; receiving movement information about the first user from the position determination device of the tracking device; and upon determining the protected time has expired, the current location of the first user is within the protected area, transmitting an alert to the monitoring system based on the movement information.

In a further aspect, a non-transitory computer-readable storage medium storing instructions may include executed by a computing system, cause the computing system to perform a process for intelligent tracking, the process including receiving task data from a monitoring system for a task associated with a tracking device, where the tracking device is assigned to a first user. The task data includes a protected start time of the task, a protected end time of the task, a location of the task, and geospatial data associated with the location of the task. The process includes determining a protected time based on the protected start time and the protected end time. The process includes determining a protected area based on the location of the task and the geospatial data associated with the location of the task. The process also includes receiving a current location of the first user from the tracking device and receiving movement information about the first user from the tracking device. Upon determining the protected time has expired, the current location of the first user is within the protected area, the process includes transmitting an alert to one or more devices based on the movement information.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1A is a block diagram of an intelligent tracking system according to one exemplary embodiment;

FIG. 1B is a block diagram of an example intelligent tracking system, according to one example embodiment;

FIG. 2 is a process flow diagram of a method for intelligent tracking according to an exemplary embodiment;

FIG. 3 is a process flow diagram of a method for intelligent tracking according to another exemplary embodiment; and

FIG. 4 is a process flow diagram of a method for intelligent tracking according to another exemplary embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The embodiments described here are directed to an intelligent tracking system and method including and specifically to an intelligent tracking system that reduces false alarms by implementing user specific criteria. Lone worker safety systems are critical for ensuring the well-being of individuals performing tasks in potentially hazardous environments. As an illustrative example, a utility worker is dispatched to a remote location to repair a downed power line. This utility worker travels alone in a utility vehicle to the remote location with the equipment necessary to fix the downed power line in a potentially hazardous environment. In these lone worker scenarios the worker is isolated, potentially in hazardous conditions (e.g., extreme weather, rugged terrain), and is engaged in job specific risks, for example, handling live electrical lines, working at a high height, or operating heavy and/or potentially dangerous machinery.

Some lone worker safety systems rely on scheduled check-ins, where messages are transmitted to the worker's device at predetermined intervals (e.g., 8 a.m., noon, 4 p.m.), requiring a timely response to confirm safety. While this method provides regular monitoring, it is prone to false alarms if a worker inadvertently misses a check-in due to focusing on job duties, driving to a job site, distraction or signal issues. Alternatively, some systems use manual self-check-ins, requiring the worker to actively report their status before starting a dangerous task. This approach can be inconvenient for the worker and does not provide regular monitoring from a supervising source.

Accordingly, the technology disclosed herein provides a technological improvement of these safety systems by transmitting targeted incident alerts based on time, a protected area, and movement of the worker. This additional targeted intelligence and tracking provides a technological benefit to the functioning of safety systems in the localization and identification of an incident thereby minimizing false alarms.

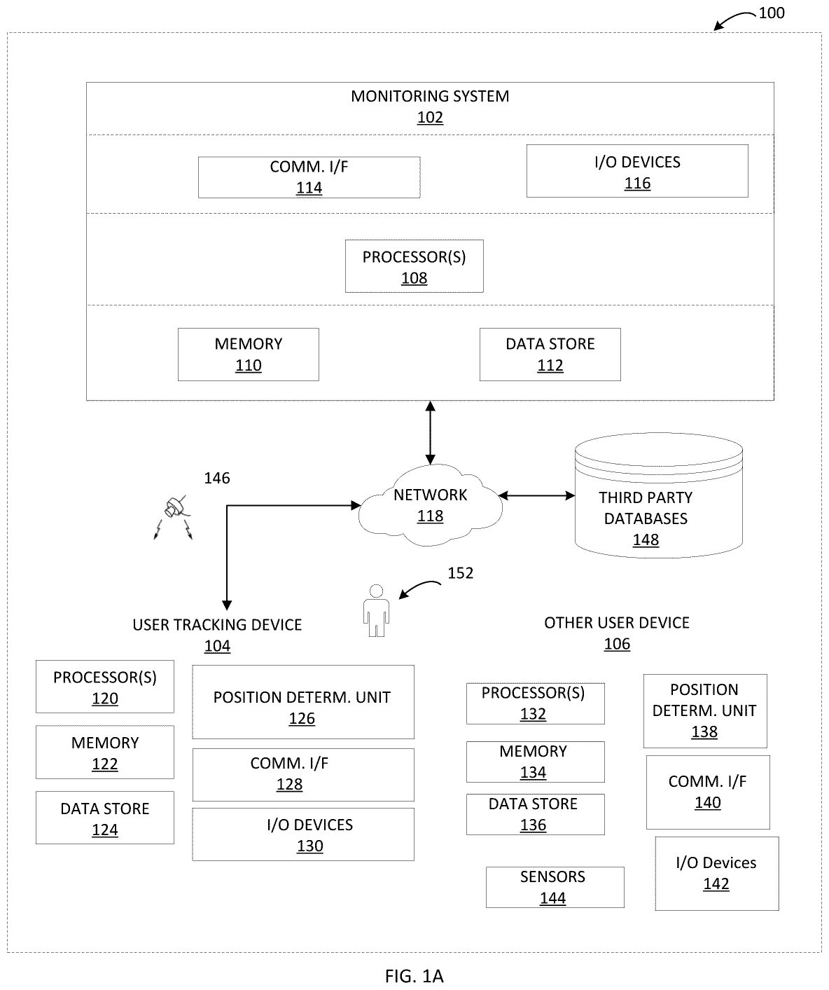

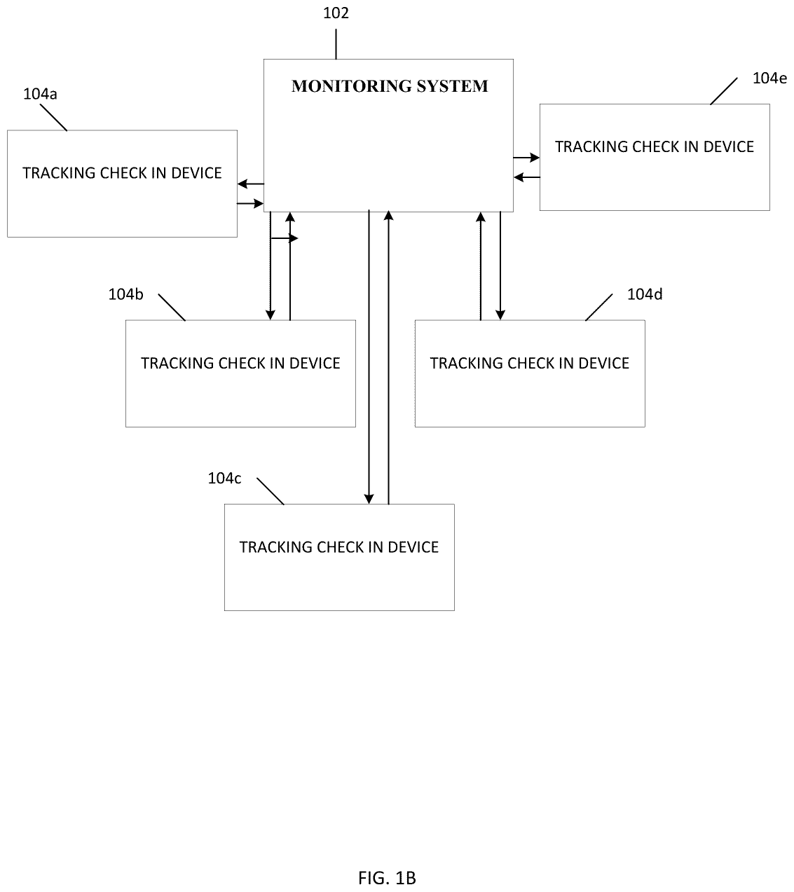

Referring now to the drawings, wherein the showings are for purposes of illustrating one or more exemplary embodiments and not for purposes of limiting the same, FIG. 1A is a block diagram of an exemplary operating environment for an intelligent tracking system 100 according to one exemplary embodiment. The intelligent tracking system 100 includes a monitoring system 102 and a user tracking device 104. Generally, the monitoring system 102 includes processor(s) 108, a memory 110, a data store 112, a communication interface (I/F) 114, and input/output devices 116, where are each operably connected for computer communication via a wired or wireless technology discussed herein.

The monitoring system 102 can include provisions for processing, communicating, and interacting with various components of the monitoring system 102 and other components of the intelligent tracking system 100 including the user tracking device 104 and other user device 106. In particular, the processor(s) 108 can include logic circuitry with hardware, firmware, and software architecture frameworks for facilitating control of the monitoring system 102 and communication between the monitoring system 102 and other components of the intelligent tracking system 100. Thus, in some embodiments, the processor(s) 108 can store application frameworks, kernels, libraries, drivers, application program interfaces, among others, to execute and control hardware and functions discussed herein. In some embodiments, the memory 110 and/or the data store (e.g., disk) 112 can store similar components as the processor(s) 108 for execution by the processor(s) 108.

The communication I/F 114 can include software and hardware to facilitate data input and output between the components of the monitoring system 102 and other components of the intelligent tracking system 100. Specifically, the communication I/F 114 can include network interface controllers (not shown) and other hardware and software that manages and/or monitors connections and controls bi-directional data transfer between the communication I/F 114 and other components of the system 100 using, for example, a network 118. As another example, the communication I/F 114 can facilitate communication (e.g., exchange data and/or transmit messages) with the user tracking device 104. For example, as will be discussed herein, the monitoring system 102 via the communication I/F 114 can transmit check-in requests to the user tracking device 104 and responsive to the check-in request, receive a response from the user tracking device 104.

Input/output devices 116 provide input to the processor(s) 108 and/or output to other components of the system 100. Input/output devices can include, but are not limited to, a mouse, keyboard, a touchscreen, a touchpad, a wearable input device, a camera, a microphone, among others. The input/output devices 116 can also include a display to display text and graphics. It is understood that other input/output devices can also be coupled to the processor) (s) 108, for example, disk drives, media devices, etc.

The user tracking device 104 includes processors(s) 120, a memory 122, a data store 124, a position determination unit 126, a communication interface (I/F) 128, and input/output devices 130. The user tracking device 104 is associated with a first user 152. As an illustrative example, the user tracking device 104 is a portable device in possession of the first user 152. The user tracking device 104 can include provisions for processing, communicating, and interacting with various components of the user tracking device 104 and other components of the system 100, for example, the monitoring system 102. The processor(s) 120 can include logic circuitry with hardware, firmware, and software architecture frameworks for facilitating control of the user tracking device 104 and communication between the user tracking device 104 and other components of the intelligent tracking system 100. Thus, in some embodiments, the processor(s) 108 can store application frameworks, kernels, libraries, drivers, application program interfaces, among others, to execute and control hardware and functions discussed herein. In some embodiments, the memory 122 and/or the data store (e.g., disk) 124 can store similar components as the processor(s) 120 for execution by the processor(s) 120.

The position determination unit 126 can include hardware (e.g., sensors) and software to determine and/or acquire position data about the user tracking device 104. For example, the position determination unit 126 can include a global positioning system (GPS) and GPS receivers (not shown) and/or an inertial measurement unit (IMU) (not shown). Thus, the position determination unit 126 can provide a geodata about the user tracking device 104 based on satellite data from, for example, a global position source 146, or from any Global Navigational Satellite infrastructure (GNSS), including GPS, Glonass (Russian) and/or Galileo (European). In some embodiments, the position determination unit 126 can provide dead-reckoning data or motion data from, for example, a gyroscope, accelerometer, magnetometers, among other sensors (not shown).

The communication I/F 128 can include software and hardware to facilitate data input and output between the components of the user tracking device 104 and other components of the intelligent tracking system 100. Specifically, the communication I/F 128 can include network interface controllers (not shown) and other hardware and software that manages and/or monitors connections and controls bi-directional data transfer between the communication I/F 128 and other components of the system 100 using, for example, a network 118.

Input/output devices 130 provide input to the processor(s) 120 and/or output to other components of the system 100. Input/output devices can include, but are not limited to, a mouse, keyboard, a touchscreen, a touchpad, a wearable input device, a camera, a microphone, among others. The input/output devices 130 can also include a display to display text and graphics. It is understood that other input/output devices can also be coupled to the processor) (s) 120, for example, disk drives, media devices, etc.

The other user device 106 can be another portable device associated with the first user 152 (e.g., the same user associated with the user tracking device 104). In the embodiments discussed herein, the other user device 106 will be referred to as a wearable device, however, it is understood that the other user device 106 can be any type of portable device. Additionally, the system 100 can include more than one other user device 106 of different types. In FIG. 1A, the other user device 106 includes processor(s) 132, a memory 134, a data store 136, a position determination unit 138, a communication interface (I/F) 140, input/output devices 142, and sensors 144.

The other user device 106 can include provisions for processing, communicating, and interacting with various components of the other user device 106 and other components of the intelligent tracking system 100 including the monitoring system 102 and the user tracking device 104. In particular, the processor(s) 132 can include logic circuitry with hardware, firmware, and software architecture frameworks for facilitating control of the other user device 106 and communication between the other user device 106 and other components of the intelligent tracking system 100. Thus, in some embodiments, the processor(s) 132 can store application frameworks, kernels, libraries, drivers, application program interfaces, among others, to execute and control hardware and functions discussed herein. In some embodiments, the memory 134 and/or the data store (e.g., disk) 136 can store similar components as the processor(s) 132 for execution by the processor(s) 132.

The position determination unit 138 can include hardware (e.g., sensors) and software to determine and/or acquire position data about the other user device 106. It is understood that the position determination unit 138 can include the same and/or similar components and functions as the position determination unit 126 of the user tracking device 104, discussed in detail above.

The communication I/F 140 can include software and hardware to facilitate data input and output between the components of the other user device 106 and other components of the intelligent tracking system 100. Specifically, the communication I/F 140 can include network interface controllers (not shown) and other hardware and software that manages and/or monitors connections and controls bi-directional data transfer between the communication I/F 140 and other components of the system 100 using, for example, a network 118. As an example, the communication I/F 140 can facilitate communication (e.g., exchange data and/or transmit messages) with the monitoring system 102 and/or the user tracking device 104.

Input/output devices 142 provide input to the processor(s) 132 and/or output to other components of the system 100. Input/output devices can include, but are not limited to, a mouse, keyboard, a touchscreen, a touchpad, a wearable input device, a camera, a microphone, among others. The input/output devices 116 can also include a display to display text and graphics. It is understood that other input/output devices can also be coupled to the processor) (s) 108, for example, disk drives, media devices, etc.

Generally, sensors 144 discussed herein sense and measure a stimulus (e.g., a signal, a property, a measurement, a quantity) associated with the other user device 106 and/or a user associated with the other user device 106. The sensors can generate a data stream and/or a signal representing the stimulus, analyze the signal and/or transmit the signal to another component, for example the processor(s) 132, which in turn can be transmitted to another component of the system 100, for example, the monitoring system 102. In one embodiment, the sensors 144 include sensors (e.g., biometric sensors) that measure an internal characteristic of an individual (e.g., biometric data). In the case of a wearable device, the wearable device is worn by the user and sensors 144 can measure data about the user. For example, the sensors 144 can include heart rate sensors, blood pressure sensors, oxygen content sensors, among others. The sensors 144 can be of any types, for example, optical sensors, thermal sensors, image sensors, inductive sensors, temperature sensors, among others.

In some embodiments, the sensors 144 can measure motion information about the other user device 106 and/or the first user 152. For example, motion information form imaging sensors can provide information about a pose of the first user 152 over a period of time thereby indicating whether the first user 152 is in a state of motion. It is understood that in some embodiments, the user tracking device 104 can include one or more of the sensors 144 discussed herein. For example, in some embodiments, the user tracking device 104 can include biometric sensors that measure biometric data about the first user 152.

As illustrated in FIG. 1B, the monitoring system 102 is in communication with a plurality of tracking check in devices 104a-104e. In this example embodiment, the plurality of tracking check in devices 104a-104e comprise same or different devices, wherein a first tracking check in device 104a comprises a smartphone of a first user 152, a second check in device 104b comprises a dedicated device of a second user, etc.

Referring now to FIG. 200, a method 200 for intelligent tracking is shown. At block 202, the method 200 includes receiving a protected start time and a protected end time. In one embodiment, the protected start time is a start time of a shift associated with a first user 152 and the protected end time is the end time of the shift associated with the first user 152. The first user 152 is associated with at least one tracking device, for example the user tracking device 104. In another embodiment, the protected start time is a start time of a task assigned to a first user 152. For example, the time in which the first user 152 begins the task. In this embodiment, the protected end time is an end time of the task assigned to the first user 152. For example, the protected end time can be an estimated end time at which the first user 152 completes the task.

In one example embodiment, the protected start time and the protected end time are assigned a time zone wherein the user tracking device 104 is located and changed into local time responsive to the user tracking device 104 being in a different time zone than the monitoring system 102. In another example embodiment, the protected start time and the protected end time are assigned are in Coordinated Universal Time. The monitoring system 102 can receive the protected start time and the protected end time from a task database (e.g., memory 110 and/or data store 112). In another example, the protected start time and the protected end time is transmitted from the user tracking device 104 to the monitoring system 102. In another example, the protected start time and the protected end time is received based on input using, for example, the I/O devices 116.

At block 204, the method 200 includes determining a protected time based on the protected start time and the protected end time. For example, the processor(s) 108 determine the protected time as the time between the protected start time and the protected end time.

At block 206, the method 200 includes determining a protected area. In one example, the protected area is associated with the task, the protected time and the first user 152. For example, the protected area can be a geolocation where the task takes place during the protected time. In one example, the parameters of the protected area are input by an external user. In another example embodiment, the protected area is pulled from stored data, In another embodiment, discussed in more detail herein, the protected area is determined based on geospatial data.

In one example embodiment, the protected area is a geographically defined boundary, for example, a polygon. The protected area can be provided as GPS coordinates. In one example embodiment, a total area of the protected area (e.g., in square miles) is based upon a detected average pace of a particular user, wherein the particular user is tracked over time by the user tracking device 104. In this example embodiment, an average or mean pace (e.g., distance covered over time) is identified for the particular user and iteratively updated over time based on stored data related to that particular user's past detected pace and topology of a given protected area. In another example embodiment, a vertical distance is considered when assigning the protected area. For example, wherein a targeted area (e.g., where the particular user is supposed to go) includes vertical distances (e.g., steep hills or mountains) the protected area is reduced and alternately, wherein the targeted area is flat or lacks vertical distances, the protected area is increased.

In one example, the protected area is a high-risk area determined based on geospatial data. The geospatial data can include at least geolocation data, meteorological data, and geological data, among others. In some embodiments, the geospatial data also includes geospatial social demographic data (e.g., population characteristics and crime rates linked to specific geographic locations). In some embodiments, geospatial data can be retrieved from third party databases 148.

In another embodiment, the monitoring system 102 can receive and/or store task data about a task associated with the user tracking device 104 and/or the first user 152. In this example, task data can be stored, for example, at the memory 110 and/or the data store 112. In some embodiments, one or more components of the task data can be retrieved from other I/O devices 116. The task data can include, for example, a protected start time of the task, a protected end time of the task, a location of the task, and geospatial data associated with the location of the task, among others. Other task data can include job characteristics, for example, tools required for the task, machinery required for the task, etc. In some embodiments, a risk level of the task can be determined based on the task data.

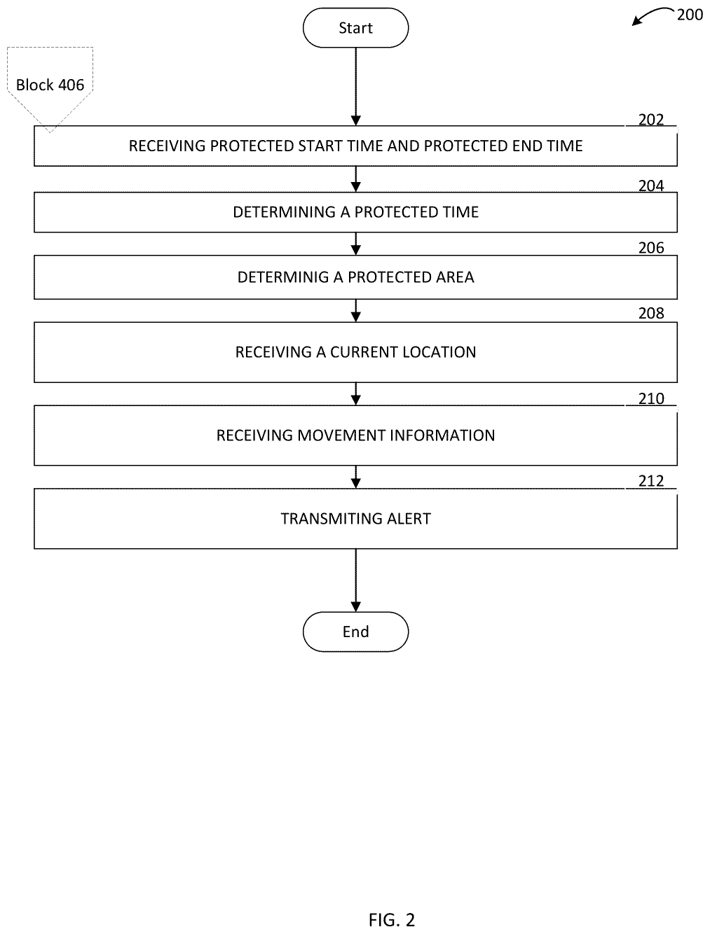

Referring again to the method 200 of FIG. 2, at block 208, the method 200 includes receiving a current location of the first user 152 from the user tracking device 104. For example, the position determination unit 126 can provide a real-time current location (i.e., time-based location) of the user tracking device 104 using the GPS satellite 146 in communication with the user tracking device 104.

At block 210, the method 200 includes receiving movement information about the first user 152 from the user tracking device 104. Movement information can include information about the movement of the user tracking device 104 and/or movement of the first user 152 associated with the user tracking device 104. For example, as mentioned above, the position determination unit 126 can include an IMU, a gyroscope, accelerometers, among others, to determine motion information. Thus, the motion information can include acceleration data, angular velocity, and orientation information about the tracking device 104 and/or the first user 152.

In some embodiments, the method 200 includes determining a motion state of the first user 152 based on the movement information. For example, with respect to a motion state, the first user 104 can be moving, not moving. A motion state can also be determined according to the speed of movement or the pace at which the first user 152. For example, slow speed (e.g., controlled, sluggish), moderate speed (e.g., steady and controlled), fast speed (e.g., rapid).

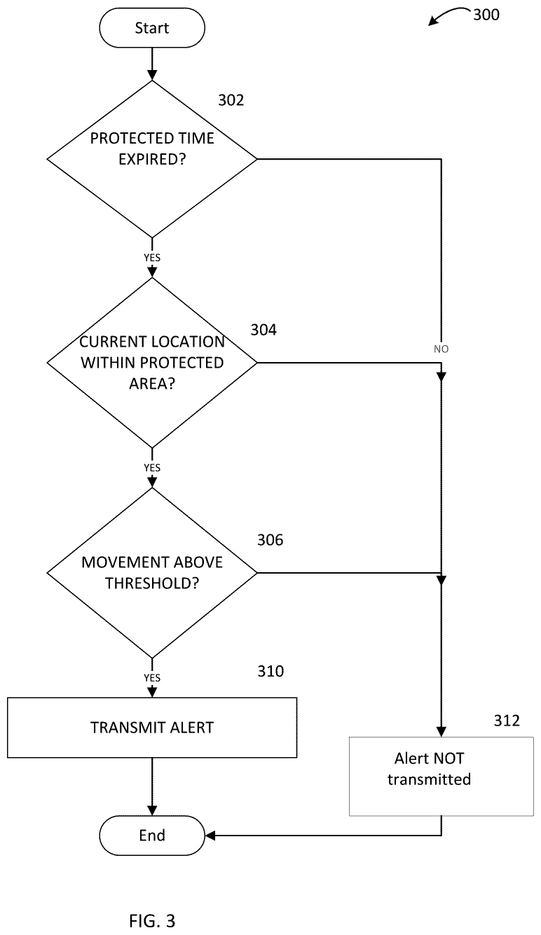

At block 212, the method 200 includes transmitting an alert based on the protected time, the current location of the first user 152, and the movement information about the first user 152. In one embodiment, the user tracking device 104 is controlled to transmit an alert to the monitoring system 102. For example, the processor 120 can transmit a signal to the monitoring system 102 including the current location of the user tracking device 104 and/or the first user 152 and the movement information about the first user 152. In one embodiment, the processor(s) 108 and/or the processors (120) are controlled to transmit an alert to a third party, for example, an first responder system. In some embodiments, transmitting the alert is also based on biometric data about the first user 152. For example, data gathered by the sensors 144. Block 212 will now be discussed in more detail with the method 300 shown in FIG. 3.

At block 302, the method 300 includes determining if the protected time has expired. Said differently, it is determined if a current time is after the protected end time. If the determination at block 302 is NO, method 300 proceeds to 312 where an alert is not transmitted and the method 300 ends.

At block 304, the method 300 includes determining if the current location is within the protected area. For example, the monitoring system 102 determines whether (e.g., from a satellite, such as GPS satellite in communication with the user tracking device 104) the user tracking device 104 is in the protected area. At 312, responsive to the monitoring system 102 determining that the user tracking device 104 is not in the protected area, the monitoring system 102 does not issue an alert and the method 300 ends. In this example embodiment, the monitoring system 102 stores both current and past time and location data for the user tracking device 104 and updates the time and location data as such data is received. In one example embodiment, the current and past time and location data for the user tracking device are assigned to the first user 152 and are utilized to iteratively update a profile of the first user 152.

At block 306, the method 300 includes determining if the movement is above a movement threshold based on the movement information. Said differently, at block 306, it is determined if the user tracking device 104 and/or the first user 152 are in a moving state based on the movement information. In one embodiment, moving is wherein the user tracking device 104 is travelling over a movement threshold for a duration threshold. In one example embodiment, the movement threshold is a rate of regular walk or faster (e.g., three miles per hour). In one example embodiment, the duration threshold is greater than thirty seconds to about one minute.

At 312, responsive to the monitoring system 102 determining that the user tracking device 104 and/or the first user 152 is moving, the monitoring system 102 does not issue an alert, and the method 300 ends. At 310, responsive to the monitoring system 102 determining that the user tracking device 104 and/or the first user 152 is not moving, the monitoring system issues an alert. In one example embodiment, the alert comprises location information about the user tracking device 104 and/or the first user 152. It would be understood by one of ordinary skill in the art that both methods 200 and 300 are usable for a plurality of users having a plurality of check in devices 104a-104e. In one example embodiment, at 310, the monitoring system 102 issues an alert when the user has not moved over the movement threshold for an alert duration (e.g., between 1 to 2 hours).

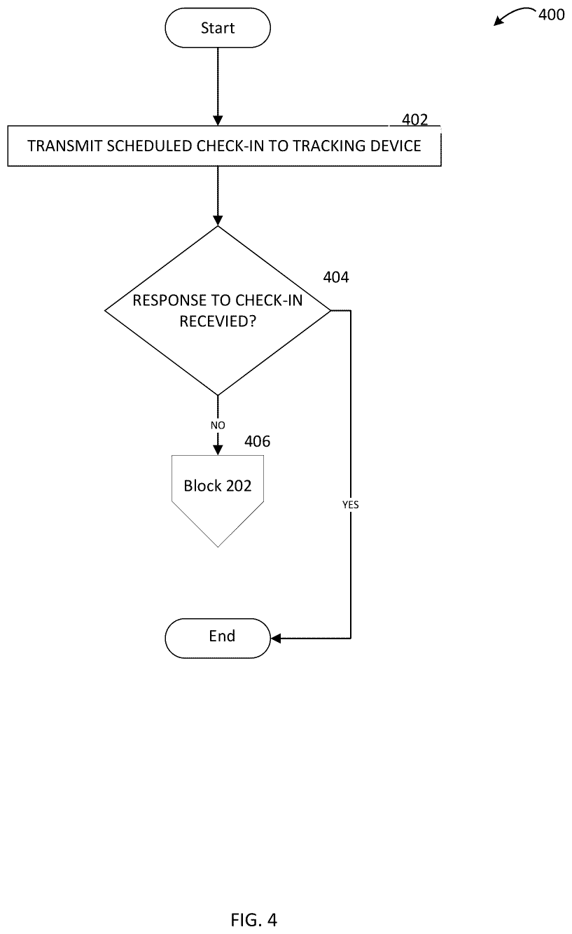

In some embodiments, the monitoring methods described herein with respect to methods 200 and 300 are initiated upon determining the first user 152 has missed a check-in. As mentioned previously, some systems rely on scheduled check-ins, where messages are sent to the worker's device at predetermined intervals (e.g., 8 a.m., noon, 4 p.m.), requiring a timely response to confirm safety. In many situations, a worker has simply missed the check-in and is not in danger, creating a false alarm. However, the methods described herein can be used as a redundancy check and transmit an alarm only if a safety issue truly exists. Referring now to FIG. 4, a method 400 for initiating the method 200 for intelligent tracking shown in FIG. 2 will now be discussed. At block 402, the monitoring system 102 transmits a scheduled check-in message to the user tracking device 104. At block 404, the method 400 includes determining if a response to the check-in message was received. If a response was received (YES), the method 400 ends and the method 200 for intelligent tracking is not initiated. However, if a response to the check-in was not received, the method 400 proceeds to block 406, where the method for 200 is initiated at block 202.

Advantageously, the intelligent tracking system 100 prevents alerts from being incorrectly sent, by confirming the user is in the area of danger and is not moving. Preventing incorrectly sent alerts saves time and resources and prevents alarm fatigue.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

### DEFINITIONS

The following includes definitions of selected terms employed herein. The definitions include various examples and/or forms of components that fall within the scope of a term and that may be used for implementation. The examples are not intended to be limiting. Further, the components discussed herein, may be combined, omitted or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more computing devices (e.g., computer, personal digital assistant, cellular telephone, network device, vehicle, vehicle computing device, infrastructure device, roadside device) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless area network (WAN), a wide area network (WAN), a metropolitan area network (MAN), a virtual private network (VPN), a cellular network, a token ring network, a point-to-point network, an ad hoc network, a mobile ad hoc network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. A database may be stored, for example, at a disk and/or a memory.

“Disk,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Operable connection,” or a connection by which entities are “operably connected,” is one in which signals, physical communications, and/or logical communications may be sent and/or received. An operable connection may include a wireless interface, a physical interface, a data interface, and/or an electrical interface.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

The embodiments discussed herein may also be described and implemented in the context of “computer-readable medium” or “computer storage medium.” As used herein, “computer-readable medium” or “computer storage medium” refers to a non-transitory medium that stores instructions, algorithms, and/or data configured to perform one or more of the disclosed functions when executed. Computer-readable medium may be non-volatile, volatile, removable, and non-removable, media implemented in any method or technology for storage of information such as computer readable instructions, data structures, modules or other data. Computer-readable medium may include, but is not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device may interface with. Computer-readable medium excludes non-transitory tangible media and propagated data signals.

1. A method for intelligent tracking, comprising:
receiving a protected start time and a protected end time for a task assigned to a first user from a monitoring system, wherein the first user is associated with at least one tracking device;
determining a protected time based on the protected start time and the protected end time;
determining a protected area associated with the task, the protected time and the first user, based on geospatial data;
receiving a current location of the first user from the tracking device;
receiving movement information about the first user from the tracking device; and
upon determining the protected time has expired, the current location of the first user is within the protected area, transmitting an alert to one or more devices based on the movement information.

2. The method of claim 1, wherein the protected time is a time between the protected start
time and the protected end time.

3. The method of claim 1, wherein the geospatial data includes at least meteorological data
and geological data, and wherein the protected area is a high-risk area determined based on the geospatial data.

4. The method of claim 3, wherein the geospatial data also includes geospatial social
demographic data, and wherein determining the protected area is based on the geospatial social demographic data.

5. The method of claim 1, including upon determining based on the movement information
that the first user has not moved over a movement threshold for a movement duration, transmitting the alert.

6. The method of claim 1, including upon determining a scheduled check-in from the
tracking device associated with the first user is not received by the monitoring system, initiating the method for intelligent tracking.

7. The method of claim 1, further including a wearable device associated with the tracking
device and the first user, wherein the wearable device measures biometric data about the first user.

8. The method of claim 7, wherein transmitting an alert to the one or more devices is based
on the movement information and the biometric data.

9. A computing system for intelligent tracking, the computing system comprising:
a monitoring system;
a tracking device associated with a first user, the tracking device having a position determination device; and
one or more processors operatively connected for computer communication to the monitoring system and the tracking device, and one or more memories storing instructions that when executed by the one or more processors, cause the computing system to perform an intelligent tracking process, comprising:
determines a protected time based on a protected start time and a protected end time received from the monitoring system, wherein the protected time is associated with a task assigned to the first user;
determines a protected area based on geospatial data from the monitoring system and the tracking device, wherein the protected area is associated with the task, the protected time and the first user.
receives a current location of the first user from the position determination device of the tracking device;
receiving movement information about the first user from the position determination device of the tracking device; and
upon determining the protected time has expired, the current location of the first user is within the protected area, controlling the tracking device to transmits an alert to the monitoring system based on the movement information.

10. The computing system of claim 9, wherein the geospatial data includes at least meteorological data and geological data, and wherein the protected area is a high-risk area determined based on the geospatial data.

11. The computing system of claim 9, wherein the computing system determines based on the
movement information that the first user has not moved over a movement threshold for a movement duration, transmitting the alert.

12. The computing system of claim 9, wherein the monitoring system transmits a scheduled
check-in message to the tracking device, and upon determining a response to the scheduled check-in message is not received by the monitoring system, initiating the intelligent tracking process.

13. The computing system of claim 9, wherein the position determination device includes at least one GPS receiver in communication with at least one GPS satellite, and
GPS data from the tracking device includes a time-based location of the tracking device.

14. The computing system of claim 9, wherein the tracking device includes biometric sensors
and measures biometric data about the first user, wherein transmitting an alert to the one or more devices is based on the movement information and the biometric data.

15. A non-transitory computer-readable storage medium storing instructions that, when
executed by a computing system, cause the computing system to perform a process for intelligent tracking, the process comprising:
receiving task data from a monitoring system for a task associated with a tracking device, wherein the tracking device is assigned to a first user, wherein the task data includes a protected start time of the task, a protected end time of the task, a location of the task, and geospatial data associated with the location of the task;
determining a protected time based on the protected start time and the protected end time;
determining a protected area based on the location of the task and the geospatial data associated with the location of the task;
receiving a current location of the first user from the tracking device;
receiving movement information about the first user from the tracking device; and
upon determining the protected time has expired, the current location of the first user is within the protected area, transmitting an alert to one or more devices based on the movement information.

16. The non-transitory computer-readable storage medium of claim 15, wherein the protected
time is a time between the protected start time and the protected end time.

17. The non-transitory computer-readable storage computer-readable storage medium of
claim 15, wherein the geospatial data includes at least meteorological data and geological data, and wherein the protected area is a high-risk area determined based on the geospatial data.

18. The non-transitory computer-readable storage computer-readable storage medium of
claim 17, wherein the geospatial data also includes geospatial social demographic data, and wherein determining the protected area is based on the geospatial social demographic data.

19. The non-transitory computer-readable storage computer-readable storage medium of
claim 15, wherein upon determining based on the movement information that the first user has not moved over a movement threshold for a movement duration, transmitting the alert.

20. The non-transitory computer-readable storage computer-readable storage medium of
claim 15, wherein upon determining a scheduled check-in from the tracking device associated with the first user is not received by the monitoring system, initiating the process for intelligent tracking.
